(19) United States
(12) Patent Application Publication
(10) Pub. No.: US 2007/0173560 A1
(43) Pub. Date: Jul. 26, 2007

(54) Non-aqueous pigment ink composition

(75) Inventor: Shunsuke Uozumi, Ibaraki-ken (JP)

Correspondence Address: FROMMER LAWRENCE & HAUG, 745 FIFTH AVENUE- 10TH FL., NEW YORK, NY, 10151, US

(73) Assignee: Riso Kagaku Corporation

(21) Appl. No.: 11/656,234

(22) Filed: Jan. 22, 2007

(30) Foreign Application Priority Data
Jan. 24, 2006 (JP) 014837/2006

(51) Int. Cl. C09D 11/00

(52) U.S. Cl. 523/160; 524/556

(57) ABSTRACT

A non-aqueous pigment ink composition contains at least a pigment, a solvent, and non-aqueous resin dispersion fine particles having pigment dispersing ability. The non-aqueous resin dispersion fine particles may be obtained from copolymerization of a polymerizable monomer mixture containing, as principal constituents, (meth) acrylic acid alkyl ester monomers, which are soluble in a solvent and which are capable of being insolubilized by undergoing polymerization. The (meth) acrylic acid alkyl ester monomers may contain: (i) at least one kind of monomer having a long chain alkyl group having 12 to 25 carbon atoms, and (ii) at least one kind of monomer having at least one kind of functional group selected from the group consisting of a tertiary amino group, a glycidyl group, a carboxyl group, and a macromonomer having a styrene-derived functional group.

### CROSS-REFERENCE TO RELATED APPLICATION

This application is based upon and claims the benefit of priority from the prior Japanese Patent Application No. 014837/2006, filed Jan. 24, 2006, the entire contents of which are incorporated herein by reference.

### BACKGROUND OF THE INVENTION

1. Field of the Invention

This invention relates to an ink composition for use in a printer for recording information. This invention particularly relates to a non-aqueous pigment ink composition.

2. Description of the Related Art

Ink jet recording systems are printing systems for performing printing operations, in which a liquid ink composition having a high fluidity is jetted out from fine nozzles and adhered to a recording medium, such as printing paper. The ink jet recording systems have advantages in that an image having a high resolution and good image quality is capable of being printed quickly with low noise and by use of a comparatively cheap apparatus. By virtue of the advantages described above, recently, the ink jet recording systems have quickly become popular.

Coloring materials to be contained in the ink compositions for use in the ink jet recording systems may be roughly classified into the coloring materials, which utilize pigments, and the coloring materials, which utilize dyes. The ink compositions containing the pigments as the coloring materials have a high light resistance, a high weathering resistance, and a high water resistance, which are required for the printing with good image quality. Therefore, there is a tendency for the ink compositions containing the pigments as the coloring materials to be employed increasingly.

The ink compositions utilized for the ink jet recording systems may be roughly classified into aqueous type ink compositions and non-aqueous type ink compositions. The aqueous type ink compositions contain an aqueous solvent or water as the ink medium. It is not always possible to disperse the pigments finely in the aqueous ink medium and to obtain stability of the dispersed state of the pigments. From the view point described above, an aqueous pigment ink composition containing the pigments, which have been subjected to surface processing for enabling pigment dispersing in the aqueous medium, has been proposed in, for example, Japanese Unexamined Patent Publication No. 10 (1998)-204347. However, with the proposed aqueous pigment ink composition, the problems will be encountered in that, because of the aqueous type, the water resistance will not be capable of being kept high.

Accordingly, recently, non-aqueous ink compositions, which utilize a solvent other than water as the solvent for the ink composition, as in the cases of solvent type ink compositions principally containing a volatile solvent and oil type ink compositions principally containing a non-volatile solvent, have attracted particular attention. The non-aqueous ink compositions have the advantages over the aqueous ink compositions in that the drying characteristics and the printability are good. The non-aqueous ink compositions are constituted of a solvent, a resin, a pigment, and the like. However, for example, in cases where the quantity of the solvent contained in the non-aqueous ink compositions is set to be large, and the viscosity of the non-aqueous ink compositions is thereby adjusted at a value appropriate for the ink jetting out operation, the problems occur in that the concentration of the resin becomes low, and in that the resin penetrates into the recording medium together with the solvent. As a result, the problems occur in that the binding force of the resin becomes insufficient, and that the pigment fixing characteristics become bad. Also, in cases where the quantity of the resin contained in the non-aqueous ink compositions is set to be large, and the fixing characteristics of the pigment to the recording medium and the abrasion resistance of the pigment are thereby enhanced, the problems occur in that the viscosity of the ink composition becomes high, and in that nozzle clogging is apt to arise. Therefore, an optimum adjustment has heretofore been made with priority being given to either one of the viscosity of the ink composition and the pigment fixing characteristics.

Oil ink compositions containing a resin that forms a particle dispersion system, in which polymer particles insoluble in an organic medium (a high boiling temperature solvent) have been dispersed reliably, have been proposed in, for example, Japanese Unexamined Patent Publication Nos. 2005-171032 and 2005-171056. The resin that forms the particle dispersion system, in which the polymer particles insoluble in an organic medium (a high boiling temperature solvent) have been dispersed reliably, is referred to as the non-aqueous resin dispersion fine particles, i.e. non aqua dispersion particles (NAD particles). The NAD particles are insoluble in the ink composition. Therefore, the oil ink compositions containing the NAD particles exhibit good pigment fixing characteristics and a high abrasion resistance. Also, with the oil ink compositions containing the NAD particles, the solids content in the ink composition is capable of being set to be high at a viscosity lower than the viscosity of a dissolution type resin liquid, and therefore the viscosity of the ink composition is capable of being set to be low.

However, the NAD particles themselves do not have a pigment dispersing ability. Therefore, in the cases of the oil ink compositions containing the NAD particles, it is necessary for a pigment dispersing agent to be added to the ink composition. However, in cases where the pigment dispersing agent is added to the ink composition, the abrasion resistance becomes low, and therefore the pigment fixing characteristics with respect to the recording medium are not capable of being kept to be sufficiently good. Also, in cases where the concentration of the resin, including the NAD particles, is set to be high in order for the pigment fixing characteristics to be kept to be sufficiently good, the viscosity of the ink composition becomes high, and jetting-out stability becomes low. In such cases, it may be contemplated to employ a technique for processing the pigment surfaces as described in, for example, Japanese Unexamined Patent Publication No. 10(1998)-204347. However, in the cases of the non-aqueous ink compositions, the dispersibility of the pigment is not capable of being obtained with the surface processing of the pigment.

Further, with the ink composition utilizing a self-dispersible pigment as described in, for example, Japanese Unexamined Patent Publication No. 10(1998)-204347, and with the ink compositions utilizing the pigment dispersing agent as described in, for example, Japanese Unexamined Patent Publication Nos. 2005-171032 and 2005-171056, in which affinity of the pigment for the solvent is markedly high, the pigment is apt to be entrained together with the solvent into the recording paper at the time at which the solvent penetrates into the recording paper during the printing operation. As a result, the problems are encountered in that the printed image density becomes low, and in that an ink offset to the back of the printed paper is apt to occur. In order for the aforesaid problems to be solved, it is necessary that the concentration of the resin, including the NAD particles, be set to be high. However, in cases where the concentration of the resin, including the NAD particles, is set to be high, the jetting-out stability and storage stability are not capable of being kept good. Specifically, with the conventional NAD particles, which do not have the pigment dispersing ability, and with the conventional self-dispersible pigment, both the requirements for the high image density of the prints and for the good ink fixing characteristics and the requirement for the high jetting-out stability are not always capable of being satisfied at the same time.

### SUMMARY OF THE INVENTION

The primary object of the present invention is to provide a non-aqueous pigment ink composition, which is capable of yielding prints having a high image density in cases where a resin concentration in the ink composition is set to be comparatively low, and which exhibits good jetting-out stability and good storage stability without a particular pigment dispersing agent being added.

The present invention provides a non-aqueous pigment ink composition, containing at least a pigment, a solvent, and non-aqueous resin dispersion fine particles having pigment dispersing ability.

The non-aqueous pigment ink composition in accordance with the present invention should preferably be modified such that the non-aqueous resin dispersion fine particles are obtained from copolymerization of a polymerizable monomer mixture containing, as principal constituents, (meth) acrylic acid alkyl ester monomers, which are soluble in a solvent and which are capable of being insolubilized by undergoing polymerization, and

the (meth)acrylic acid alkyl ester monomers contain:

i) at least one kind of monomer having a long chain alkyl group having 12 to 25 carbon atoms, and

ii) at least one kind of monomer having at least one kind of functional group selected from the group consisting of a tertiary amino group, a glycidyl group, a carboxyl group, and a macromonomer having a styrene-derived functional group.

The term “containing, as principal constituents, (meth) acrylic acid alkyl ester monomers” as used herein means that the (meth) acrylic acid alkyl ester monomers are contained in a proportion of at least 50% with respect to the total quantity of the polymerizable monomer mixture. Also, the term “(meth) acrylic acid” as used herein means the acrylic acid and/or methacrylic acid. Further, the term “(meth) acrylate” as will be used hereinbelow means the acrylate and/or methacrylate.

Also, the non-aqueous pigment ink composition in accordance with the present invention should preferably be modified such that a proportion of a total quantity of a resin, including the non-aqueous resin dispersion fine particles, with respect to the quantity of the pigment contained in the ink composition falls within the range of 50% by mass to 100% by mass, and

the proportion of the quantity of the non-aqueous resin dispersion fine particles with respect to the total quantity of the resin, including the non-aqueous resin dispersion fine particles, is equal to at least 95% by mass.

With the non-aqueous pigment ink composition in accordance with the present invention, which contains the non-aqueous resin dispersion fine particles having the pigment dispersing ability, an interaction (adsorption force) between the pigment and the non-aqueous resin dispersion fine particles having the pigment dispersing ability is strong. Therefore, with the non-aqueous pigment ink composition in accordance with the present invention, in the region of a lower content than the non-aqueous resin dispersion fine particles which do not have the pigment dispersing ability, prints having a high image density are capable of being obtained. Also, with the non-aqueous pigment ink composition in accordance with the present invention, the solids content in the ink composition is capable of being set to be high at a viscosity lower than the viscosity of the dissolution type resin liquid, and therefore the jetting-out stability is capable of being enhanced. Further, with the non-aqueous pigment ink composition in accordance with the present invention, both the storage stability under the ordinary use environment conditions and the storage stability under high-temperature environment conditions are capable of being kept good.

Particularly, with the non-aqueous pigment ink composition in accordance with the present invention, in which the non-aqueous resin dispersion fine particles themselves have the pigment dispersing ability, a particular pigment dispersing agent need not be added, and good pigment dispersive characteristics are capable of being obtained. Therefore, the occurrence of the problems due to the use of the particular pigment dispersing agent, i.e. the problems with regard to the increase in ink viscosity and the lowering of the storage stability, is capable of being suppressed.

### DETAILED DESCRIPTION OF THE INVENTION

The non-aqueous pigment ink composition in accordance with the present invention is characterized by containing the non-aqueous resin dispersion fine particles having the pigment dispersing ability (hereinbelow referred to as the pigment dispersive NAD particles). The non-aqueous pigment ink composition in accordance with the present invention should preferably be modified such that the pigment dispersive NAD particles are obtained from the copolymerization of the polymerizable monomer mixture containing, as the principal constituents, the (meth)acrylic acid alkyl ester monomers, which are soluble in a solvent and which are capable of being insolubilized by undergoing the polymerization, and the (meth)acrylic acid alkyl ester monomers contain: (i) at least one kind of monomer having the long chain alkyl group having 12 to 25 carbon atoms, and (ii) at least one kind of monomer having at least one kind of functional group selected from the group consisting of the tertiary amino group, the glycidyl group, the carboxyl group, and the macromonomer having the styrene-derived functional group.

Preferable examples of the monomers having the long chain alkyl group having 12 to 25 carbon atoms include lauryl (meth) acrylate, cetyl (meth) acrylate, stearyl (meth) acrylate, biphenyl (meth) acrylate, iso-lauryl (meth) acrylate,.andiso-stearyl (meth) acrylate. Preferable examples of the monomers having the tertiary amino group include dimethylaminoethyl (meth) acrylate, and diethylaminoethyl (meth) acrylate. Preferable examples of the monomers having the glycidyl group include glycidyl (meth) acrylate. Preferable examples of the monomers having the carboxyl group include (meth) acrylic acid. Preferable examples of the monomers having the macromonomer having the styrene-derived functional group include a polystyrene macromonomer (AS-6, supplied by Toagosei Co., Ltd.), and a macromonomer of an acrylonitrile-styrene copolymer (AN-6, supplied by Toagosei Co., Ltd.).

The pigment dispersive NAD particles contained in the non-aqueous pigment ink composition in accordance with the present invention are constituted of the resin that has core/shell structure bodies and forms the particle dispersion system, in which the polymer particles (corresponding to the core regions of the core/shell structure bodies) insoluble in a solvent have been dispersed reliably. The resin constituting the pigment dispersive NAD particles has the pigment dispersing ability.

In order for the polymer particles to be dispersed reliably in the solvent, it is necessary that the surface of each of the polymer particles has been surrounded by the shell structure body (a steric repulsion layer). The polymer particles having the structure described above may be formed with a process described below. Specifically, a copolymer, in which a polymer moiety soluble in the solvent, a polymer moiety insoluble in the solvent, and a pigment dispersing moiety have been subjected to graft polymerization or block polymerization, is utilized as a dispersion stabilizer. The monomers are subjected to polymerization in the presence of the dispersion stabilizer. The insoluble polymer having thus been formed combines with the insoluble polymer moiety of the dispersion stabilizer and thus forms a dispersed particle nucleus. The monomers contained in the organic medium migrate little by little into the thus formed dispersed particle nucleus, and the polymerization proceeds within the particle. With the process described above, the polymer particles, each of which is surrounded by the shell structure body capable of undergoing salvation with the solvent, are formed ultimately. The pigment dispersing moiety described above should preferably be at least one kind of functional group selected from the group consisting of the tertiary amino group, the glycidyl group, the carboxyl group, and the macromonomer having the styrene-derived functional group.

The polymerizable monomer mixture employed for the formation of the pigment dispersive NAD particles in the non-aqueous pigment ink composition in accordance with the present invention may contain a monomer, such as a vinyl ether type monomer, other than the (meth) acrylic acid alkyl estermonomers in a proportion of approximately 10%, such that the pigment dispersive NAD particles are capable of being obtained, which particles have the shell structure bodies capable of undergoing the salvation with a solvent selected as the solvent and have the core regions constituted of the insoluble polymer having been formed with the shell structure bodies acting as protective colloids. For the non-aqueous pigment ink composition in accordance with the present invention, it is also possible to employ a non-aqueous dispersion referred to as the de-mixing system (or the self-emulsifying process system), in which two kinds of incompatible polymer solutions have been mixed together, in which one of the polymer solutions constitutes a homogeneous phase, and in which the other polymer solution constitutes a dispersed phase that is present in a stable state.

It is necessary that the particle diameter of the pigment dispersive NAD particles be sufficiently smaller than the nozzle diameter ordinarily, the particle diameter of the pigment dispersive NAD particles should preferably be at most 0.3 μm, and should more preferably be at most 0.1 μm. A glass transition temperature (TG) of the pigment dispersive NAD particles should preferably be equal to at most the normal temperatures, and should more preferably be equal to at most 0° C.

The proportion of the total quantity of the resin, including the pigment dispersive NAD particles, with respect to the quantity of the pigment contained in the ink composition in accordance with the present invention should preferably fall within the range of 50% by mass to 100% by mass. Also, the proportion of the quantity of the pigment dispersive NAD particles with respect to the total quantity of the resin, including the pigment dispersive NAD particles, should preferably be equal to at least 95% by mass. If the proportion of the total quantity of the resin, including the pigment dispersive NAD particles, with respect to the quantity of the pigment contained in the ink composition in accordance with the present invention is lower than 50% bymass, enhancement of the pigment dispersing characteristics will not be capable of being expected sufficiently. If the proportion of the total quantity of the resin, including the pigment dispersive NAD particles, with respect to the quantity of the pigment contained in the ink composition in accordance with the present invention is higher than 100% by mass, the viscosity of the ink composition will become high, and a jetting-out failure due to a change with the passage of time will be caused to occur. Also, if the proportion of the quantity of the pigment dispersive NAD particles with respect to the total quantity of the resin, including the pigment dispersive NAD particles, is lower than 95% by mass, it will not be possible to obtain both the satisfactory level of the pigment dispersing characteristics and the satisfactory level of the jetting-out stability.

The concentration of the pigment dispersive NAD particles with respect to the entire ink composition should preferably fall within the range of 2% by mass to 10% by mass. If the concentration of the pigment dispersive NAD particles with respect to the entire ink composition is lower than 2% by mass, the concentration of the ink composition with respect to the recording medium will become low, and the abrasion resistance will not be capable of being kept high. If the concentration of the pigment dispersive NAD particles with respect to the entire ink composition is higher than 10% by mass, the viscosity of the ink composition will become high, and the storage stability under high-temperature environment conditions will become bad.

As the resins other than the pigment dispersive NAD particles, various resins may be employed. Examples of the resins other than the pigment dispersive NAD particles include an acrylic type resin, a styrene-acrylic type resin, a styrene-maleic acid type resin, a rosin type resin, a rosin ester type resin, an ethylene-vinyl acetate type resin, a petroleum resin, a cumarone-indene type resin, a terpene phenol type resin, a phenol resin, a urethane resin, a melamine resin, a urea resin, an epoxy type resin, a cellulose type resin, a vinyl chloride acetate type resin, a xylene resin, an alkyd resin, an aliphatic hydrocarbon resin, a butyral resin, a maleic acid resin, fumaric acid resin, a hydroxyl group-containing carboxylic acid ester, a salt of a long chain polyaminoamide with a high-molecular weight acid ester, a salt of a high-molecular weight polycarboxylic acid, a salt of a long chain polyaminoamide with a polar acid ester, a high-molecular weight unsaturated acid ester, a high-molecular weight copolymer, a modified polyurethane, a modified polyacrylate, a polyether ester type anionic surface-active agent, a naphthalenesulfonic acid formalin condensate salt, an aromatic sulfonic acid formalin condensate salt, a polyoxyethylene alkyl phosphoric acid ester, a polyoxyethylene nonyl phenyl ether, a polyester polyamine, and a stearyl amine acetate.

The solvent, which may be contained in the non-aqueous pigment ink composition in accordance with the present invention, maybe selected appropriately from polar organic solvents and non-polar organic solvents. From the view point of safety, the 50% running temperature of the solvent should preferably be equal to at least 160° C., and should more preferably be equal to at least 230° C. The 50% running temperature is the characteristics measured in accordance with JIS K0066 “Distillation Test Method for Chemical Products” and is defined by the temperature at which 50% by weight of the solvent has been vaporized.

Specifically, examples of the solvents include ester types of solvents having at least 14 carbon atoms in one molecule, such as methyl oleate, ethyl oleate, isopropyl oleate, butyl oleate, methyl linoleate, isobutyl linoleate, ethyl linoleate, a soybean oil methyl ester, a soybean oil isobutyl ester, and isopropyl isostearate; alcohol types of solvents having at least 12 carbon atoms in one molecule, such as isomyristyl alcohol, isopalmityl alcohol, isostearyl alcohol, isoeicosyl alcohol, and isohexacosanol; and higher fatty acid types of solvents, such as castor oil. Examples of the solvents also include commercially available aliphatic hydrocarbon types of solvents, such as Teclean N-16, Teclean N-20, Teclean N-22, Nisseki Naphthesol L, Nisseki Naphthesol M, Nisseki Naphthesol H, Solvent 0 L, Solvent 0 M, Solvent 0 H, Nisseki Isosol 300, Nisseki Isosol 400, AF-4, AF-5, AF-6, and AF-7, supplied by Nippon Oil Corporation; and Isopar G, Isopar H, Isopar L, Isopar M, Exxol D40, Exxol D80, Exxol D100, Exxol D130, and Exxol D140, supplied by Exxon Co. Examples of the solvents further include commercially available aromatic hydrocarbon types of solvents, such as Nisseki Cleansol G (an alkyl benzene), supplied by Nippon Oil Corporation.

Examples of pigments for black ink compositions include carbon black, such as furnace black, lamp black, acetylene black, and channel black; metals or metal oxides, such as copper, iron, and titanium oxide; and organic pigments, such as Ortho Nitraniline Black. The above-enumerated pigments for black ink compositions maybe used alone, or two or more of the above-enumerated pigments for black ink compositions may be used in combination.

Examples of pigments for color ink compositions include Toluidine Red, Permanent Carmine FB, Disazo Orange PMP, Lake Red C, Brilliant Carmine 6B, Quinacridone Red, Dioxane Violet, Ortho Nitraniline Orange, Dinitroaniline Orange, Vulcan Orange, Chlorinated Para Red, Brilliant Fast Scarlet, Naphthol Red 23, Pyrazolone Red, Barium Red 2B, Calcium Red 2B, Strontium Red 2B, Manganese Red 2B, Barium Lithol Red, Pigment Scarlet 3B Lake, Lake Bordeaux 10B, Anthocyn 3B Lake, Anthocyn 5B Lake, Rhodamine 6G Lake, Eosine Lake, iron oxide red, Naphthol Red FGR, Rhodamine B Lake, Methylviolet Lake, Dioxazine Violet, Naphthol Carmine FB, Naphthol Red M, Fast Yellow AAA, Fast Yellow 10G, Disazo Yellow AAMX, Disazo Yellow AAOT, Disazo Yellow AAOA, Disazo Yellow HR, Isoindolin Yellow, Fast Yellow G, Disazo Yellow AAA, Phthalocyanine Blue, Victoria Pure Blue, Basic Blue 5B Lake, Basic Blue 6G Lake, Fast Sky Blue, Alkali Blue R Toner, Peacock Blue Lake, Prussian blue, ultramarine, Reflex Blue 2G, Reflex Blue R, Alkali Blue G Toner, Brilliant Green Lake, Diamond Green Thioflavine Lake, Phthalocyanine Green G, Green Gold, Phthalocyanine Green Y, iron oxide powder, rust powder, zinc white, titanium oxide, calcium carbonate, clay, barium sulfate, alumina white, aluminum powder, bronze powder, a daylight fluorescent pigment, and a pearl pigment. The above-enumerated pigments for color ink compositionsmaybe usedalone, or two ormoreof the above-enumerated pigments for color ink compositions may be used in combination.

Examples of polymerization initiators, which may be used for the preparation of the non-aqueous pigment ink composition in accordance with the present invention, include peroxides, such as t-butylperoxybenzoate, di-t-butyl peroxide, cumene perhydroxide, acetyl peroxide, benzoyl peroxide, and lauroyl peroxide; and azo compounds, such as azobisisobutyronitrile, azobis-2,4-dimethylvaleronitrile, and azobiscyclohexanecarbonitrile.

The non-aqueous pigment ink composition in accordance with the present invention may further contain a nozzle clogging preventive agent, an antiseptic agent, an antioxidant, an electric conductivity adjusting agent, a pH adjusting agent, a viscosity modifier, a surface tension adjusting agent, and an oxygen absorbing agent.

Examples of antiseptic agents and mildew-proofing agents include sodium benzoate, a pentachlorophenol sodium salt, a 2-pyridinethiol-1-oxide sodium salt, a sorbic acid sodium salt, a dehydroacetic acid sodium salt, and 1,2-dibenzylthiazolin-3-one (Proxel CRL, Proxel BDN, Proxel GXL, Proxel XL-2, and Proxel TN, supplied by Avisia Co.).

Examples of pH adjusting agents, dissolution assistants, or antioxidants include amines and modified amines, such as diethanolamine, triethanolamine, propanolamine, and morpholine; inorganic salts, such as potassium hydroxide, sodium hydroxide, and lithium hydroxide; ammonium compounds, such as ammonium hydroxide and quaternary ammonium hydroxides (e.g., tetramethylammonium hydroxide); carbonates, such as potassium carbonate, sodium carbonate, and lithium carbonate; phosphates; urea and urea compounds, such as N-methyl-2-pyrrolidone, urea, thiourea, and tetramethylurea; allophanate and allophanate compounds, such as allophanate and methyl allophanate; biuret and biuret compounds, such as biuret, dimethyl biuret, and tetramethyl biuret; and L-ascorbic acid and its salts.

The present invention will further be illustrated by the following non-limitative examples.

### EXAMPLES

### Example 1

In a four-neck flask, acrylic acid alkyl ester monomers were mixed together in proportions listed in the column for Example 1 in Table 1 shown later, such that the total quantity might be equal to 17.1 g. Also, as polymerization initiators, 1.0 g of V601 (supplied by Wako Pure Chemical Industries, Ltd.), 120.0 g of AF7 (Solvent AF 7, supplied by Nippon Oil Corporation), 132.0 g of IOP (isooctyl palmitate, supplied by Nikko Chemicals Co.), and 12.0 g of FOC180 (Fine Oxocol 180, supplied by Nissan Chemical Industries, Ltd.) were added. The resulting mixture was subjected to reaction under reflux at 80° C. for six hours, and a 6.1% liquid of pigment dispersive NAD particles was thereby obtained. Thereafter, 93.7 g of the thus obtained pigment dispersive NAD particles liquid and 6.0 g of a pigment were mixed together. The resulting mixture was subjected to preliminary dispersing processing with zirconia beads in a rocking mill (supplied by Seiwa Giken Co.) for 30 minutes. After the dispersing processing, the zirconia beads were removed from the mixture. The mixture was then subjected to filtering processing with a 3.0 m membrane filter and thereafter to filtering processing with a 0.8 μm membrane filter, and dust and coarse particles were thus removed from the mixture. In this manner, an ink composition, in which the pigment had been dispersed by the pigment dispersive NAD particles, was obtained.

### Example 2

A 16.7% liquid of pigment dispersive NAD particles was obtained under the same conditions as those for the pigment dispersive NAD particles in Example 1, except that acrylic acid alkyl ester monomers were mixed together in proportions listed in the column for Example 2 in Table 1 shown later, such that the total quantity might be equal to 16.2 g. Thereafter, an ink composition, in which the pigment had been dispersed by the pigment dispersive NAD particles, was obtained in the same manner as that in Example 1, except that 32.4 g of the thus obtained pigment dispersive NAD particles liquid was used, and except that the blending proportions listed in the column for Example 2 in Table 1 shown later were employed.

### Example 3

A 15.6% liquid of pigment dispersive NAD particles was obtained under the same conditions as those for the pigment dispersive NAD particles in Example 1, except that acrylic acid alkyl ester monomers were mixed together in proportions listed in the column for Example 3 in Table 1 shown later, such that the total quantity might be equal to 15.0 g. Thereafter, an ink composition, in which the pigment had been dispersed by the pigment dispersive NAD particles, was obtained in the same manner as that in Example 1, except that 32.0 g of the thus obtained pigment dispersive NAD particles liquid was used, and except that the blending proportions listed in the column for Example 3 in Table 1 shown later were employed.

### Example 4

A 8.0% liquid of pigment dispersive NAD particles was obtained under the same conditions as those for the pigment dispersive NAD particles in Example 1, except that acrylic acid alkyl ester monomers were mixed together in proportions listed in the column for Example 4 in Table 1 shown later, such that the total quantity might be equal to 7.8 g. Thereafter, an ink composition, in which the pigment had been dispersed by the pigment dispersive NAD particles, was obtained in the same manner as that in Example 1, except that 32.6 g of the thus obtained pigment dispersive NAD particles liquid was used, and except that the blending proportions listed in the column for Example 4 in Table 1 shown later were employed.

### Example 5

A 32.3% liquid of pigment dispersive NAD particles was obtained under the same conditions as those for the pigment dispersive NAD particles in Example 1, except that acrylic acid alkyl ester monomers were mixed together in proportions listed in the column for Example 5 in Table 1 shown later, such that the total quantity might be equal to 31.5 g. Thereafter, an ink composition, in which the pigment had been dispersed by the pigment dispersive NAD particles, was obtained in the same manner as that in Example 1, except that 32.5 g of the thus obtained pigment dispersive NAD particles liquid was used, and except that the blending proportions listed in the column for Example 5 in Table 1 shown later were employed.

### Comparative Example 1

A 12.9% liquid of NAD particles was obtained under the same conditions as those for the pigment dispersive NAD particles in Example 1, except that acrylic acid alkyl ester monomers were mixed together in proportions listed in the column for Comparative Example 1 in Table 2 shown later, such that the total quantity might be equal to 12.0 g. Thereafter, an attempt was made to obtain an ink composition in the same manner as that in Example 1, except that 31.0 g of the thus obtained NAD particles liquid was used, and except that the blending proportions listed in the column for Comparative Example 1 in Table 2 shown later were employed. However, since the NAD particles having been obtained in the manner described above did not have the pigment dispersing ability, the formation of the ink composition was not capable of being achieved.

### Comparative Example 2

The blending proportions listed in the column for Comparative Example 2 in Table 2 shown later were employed, and the mixing processing was performed in the same manner as that in Example 1. In this manner, an ink composition was obtained.

### Comparative Example 3

A 12.9% liquid of NAD particles was obtained under the same conditions as those for the pigment dispersive NAD particles in Example 1, except that acrylic acid alkyl ester monomers were mixed together in proportions listed in the column for Comparative Example 3 in Table 2 shown later, such that the total quantity might be equal to 12.0 g. Thereafter, an ink composition was obtained in the same manner as that in Example 1, except that 31.0 g of the thus obtained NAD particles liquid was used, and except that the blending proportions listed in the column for Comparative Example 3 in Table 2 shown later were employed.

### Comparative Example 4

A 12.9% liquid of NAD particles was obtained under the same conditions as those for the pigment dispersive NAD particles in Example 1, except that acrylic acid alkyl ester monomers were mixed together in proportions listed in the column for Comparative Example 4 in Table 2 shown later, such that the total quantity might be equal to 12.0 g. Thereafter, an ink composition was obtained in the same manner as that in Example 1, except that 31.0 g of the thus obtained NAD particles liquid was used, and except that the blending proportions listed in the column for Comparative Example 4 in Table 2 shown later were employed.

### Comparative Example 5

A 22.9% liquid of NAD particles was obtained under the same conditions as those for the pigment dispersive NAD particles in Example 1, except that acrylic acid alkyl ester monomers were mixed together in proportions listed in the column for Comparative Example 5 in Table 2 shown later, such that the total quantity might be equal to 24.0 g. Thereafter, an ink composition was obtained in the same manner as that in Example 1, except that 35.0 g of the thus obtained NAD particles liquid was used, and except that the blending proportions listed in the column for Comparative Example 5 in Table 2 shown later were employed.

### (Physical Characteristics of Ink Composition)

As for each of the ink compositions having been obtained in Examples 1 to 5 and Comparative Examples 2 to 5, the particle size of the ink composition was measured with a dynamic light scattering type of particle diameter distribution apparatus (LB-500, supplied by Horiba Seisakusho K.K.). Also, the viscosity of the ink composition was measured with HAAKE Rheometer RS75.

### (Storage Stability of Ink Composition)

As for each of the ink compositions having been obtained in Examples 1 to 5 and Comparative Examples 2 to 5, the ink composition was accommodated in an enclosed vessel and was left to stand for four weeks under an environmental condition of 70° C. Thereafter, alterations of the particle size and the viscosity of the ink composition were measured. Results of the measurements were evaluated with the rating shown below. The rate of alteration of each of the particle size and the viscosity of the ink composition was calculated with the formula shown below.

[(Value after four weeks×100)/(initial value)]−100 (%)
◯: The rate of alteration of the particle size or the viscosity was less than 5%.
Δ: The rate of alteration of the particle size or the viscosity fell within the range of 5% to less than 10%.
×: The rate of alteration of the particle size or the viscosity was at least 10%.

As for each of the jetting-out stability of the ink composition, the image density of prints, the ink offset to the back of the printed paper, and the abrasion resistance described below, evaluation was made with processing, in which the ink composition was loaded into a printing system HC5000 (supplied by Riso Kagaku Corporation) and used for printing on plain paper (Riso Paper Thin Type, supplied by Riso Kagaku Corporation). With the printing system HC5000, the printing operation was performed by use of a 300 dpi line type ink jet head (having nozzles arrayed at intervals of approximately 85 μm) and through conveyance of the printing paper in a sub-scanning direction normal to the main scanning direction (i.e., the direction in which the nozzles were arrayed).

### (Jetting-Out Stability of Ink Composition)

One hundred sheets of solid images were printed successively. Each of the solid images had a size of approximately 51 mm (corresponding to 600 nozzles) in the main scanning direction×260 mm in the sub-scanning direction. In cases where an ink composition jetting-out failure occurred during the printing of the solid images, the non-printed region occurring due to the jetting out failure was seen as a white streak. An investigation was made to find how many white streaks occurred on 100 sheets of the prints (corresponding to 60,000 nozzles in total), and the jetting-out stability was evaluated with the rating shown below.
◯: No jetting-out failure occurred.
Δ: The number of the white streaks having occurred was less than five.
×: The number of the white streaks having occurred was at least five.

### (Image Density of Prints)

The OD value of the prints was measured, and the image density of the prints was evaluated with the rating shown below.
◯: The OD value was at least 1.1.
Δ: The OD value fell within the range of 1.0 to less than 1.1.
×: The OD value was less than 1.0.

### (Ink Offset to the Back of Printed Paper)

The prints were inspected visually, and the ink offset to the back of the printed paper was evaluated with the rating shown below.
◯: A perceptible ink offset to the back of the printed paper was not found.
Δ: A slight ink offset to the back of the printed paper was found.
×: A perceptible ink offset to the back of the printed paper was found.

### (Abrasion Resistance)

After the printing operation had been performed, the prints were left to stand for one hour and were then rubbed five times strongly with an eraser. The degree of staining of the non-printed regions in the vicinity of the rubbed region was inspected visually, and the abrasion resistance was evaluated with the rating shown below.
◯: Staining was not found.
Δ: Slight staining allowable for the prints was found.
×: Staining adversely affecting the prints was found.

Recipes for the ink compositions and the results of the evaluation are shown in Table 1 and Table 2. In Table 1 and Table 2, reference numerals put in parentheses represent the suppliers of the corresponding constituents. The constituents, which are not appended with the reference numerals in parentheses, are the constituents supplied by Wako Pure Chemical Industries, Ltd.

TABLE 1

| | | Abbreviation | Name | Ex. 1 | Ex. 2 | Ex. 3 | Ex. 4 | Ex. 5 |
|---|---|---|---|---|---|---|---|---|
| NAD | Acrylic acid | VMA | Behenyl methacrylate (*1) | | 2.3 | 1.9 | 1.1 | 4.5 |
| particle | alkyl ester | LMA | Lauryl methacrylate | 2.4 | | | | |
| recipe | monomer | AA | Acrylic acid | | 0.8 | 0.6 | 0.4 | 1.5 |
| | | DM | Dimethylaminoethyl methacrylate | 0.6 | | | | |
| | | GM | Glycidyl methacrylate (*1) | 0.6 | 0.6 | 0.5 | 0.3 | 1.2 |
| | | EHMA | 2-Ethylhexyl methacrylate | 1.8 | 1.7 | 1.4 | 0.8 | 3.3 |
| | | AS-6 | Styrene macromer (*2) | 0.3 | | | | |
| | Solvent | AF7 | Naphthene type solvent(*3) | 40.0 | 27.0 | 27.0 | 30.0 | 22.0 |
| | | IOP | Isooctyl palmitate (*4) | 44.0 | | | | |
| | | FOC180 | Higher alcohol (*5) | 4.0 | | | | |
| | Polymerization | V65 | 2,2′-Azobis(2,4-dimethyl | | 0.2 | 0.2 | 0.2 | 0.2 |
| | initiator | | valeronitrile) | | | | | |
| | | | (Azo type polymerization initiator) | | | | | |
| | | V601 | Dimethyl 2,2′-azobis(2-methyl | 0.3 | | | | |
| | | | propionate) | | | | | |
| | | | (Azo type polymerization initiator) | | | | | |
| | Polymerization | HQME | Hydroquinone monomethylether | 0.002 | 0.002 | 0.002 | 0.002 | 0.002 |
| | inhibitor | | | | | | | |

| | | | | | | | |
|---|---|---|---|---|---|---|---|
| Pigment | MA11 | Carbon black (*6) | 6.0 | 6.0 | 6.0 | 6.0 | 6.0 |
| Pigment dispersing agent | S28000 | Solsperse 28000 (*7) | | | | | |
| Diluent for dispersing | AF7 | Naphthene type solvent (*3) | | 18.0 | 18.0 | 18.0 | 18.0 |
| Solvent for viscosity | AF7 | Naphthene type solvent (*3) | | 23.1 | 23.1 | 23.1 | 23.1 |
| adjustment | IOP | Isooctyl palmitate (*4) | | 20.5 | 20.7 | 20.1 | 20.2 |
| Post-added resin | Tamanol | Rosin-modified phenol resin (*8) | | | 0.6 | | |
| | 420 | | | | | | |

| Number of parts of pigment | | 6.0 | 6.0 | 6.0 | 6.0 | 6.0 |
|---|---|---|---|---|---|---|
| Number of parts of polymer | | 5.7 | 5.4 | 5.0 | 2.6 | 10.5 |
| Polymer/pigment | | 0.95 | 0.90 | 0.83 | 0.44 | 1.75 |
| Physical | Viscosity (initial) | 11.6 | 9.1 | 10.3 | 8.4 | 13.5 |
| characteristics | Particle size (initial) | 90.2 | 93.7 | 91.8 | 94.2 | 94.5 |
| Evaluation | Storage stability | ∘ | ∘ | ∘ | Δ | ∘ |
| | Jetting-out stability | ∘ | ∘ | Δ | ∘ | Δ |
| | Image density of prints | ∘ | ∘ | ∘ | ∘ | ∘ |
| | Ink offset to the back of printed paper | ∘ | ∘ | ∘ | ∘ | ∘ |
| | Abrasion resistance | ∘ | ∘ | ∘ | ∘ | ∘ |

(*1): NOF Corporation
(*2): Toagosei Co., Ltd.
(*3): Nippon Oil Corporation
(*4): Nikko Chemicals Co., Ltd.
(*5): Nissan Chemical Industries, Ltd.
(*6): Mitsubishi Chemical Corporation
(*7): Noveon, Inc.
(*8): Arakawa Chemical Industries, Ltd.

TABLE 2

| | | | | Comp. | Comp. | Comp. | Comp. | Comp. |
|---|---|---|---|---|---|---|---|---|
| | | Abbreviation | Name | Ex. 1 | Ex. 2 | Ex. 3 | Ex. 4 | Ex. 5 |
| NAD | Acrylic acid | VMA | Behenyl methacrylate (*1) | 2.3 | | 2.3 | 2.3 | 4.6 |
| particle | alkyl ester | LMA | Lauryl methacrylate | | | | | |
| recipe | monomer | AA | Acrylic acid | | | | | |
| | | DM | Dimethylaminoethyl methacrylate | | | | | |
| | | GM | Glycidyl methacrylate (*1) | | | | | |
| | | EHMA | 2-Ethylhexyl methacrylate | 1.7 | | 1.7 | 1.7 | 3.4 |
| | | AS-6 | Styrene macromer (*2) | | | | | |
| | Solvent | AF7 | Naphthene type solvent (*3) | 27.0 | | 27.0 | 27.0 | 27.0 |
| | | IOP | Isooctyl palmitate (*4) | | | | | |
| | | FOC180 | Higher alcohol (*5) | | | | | |
| | Polymerization | V65 | 2,2′-Azobis(2,4-dimethyl | 0.2 | | 0.2 | 0.2 | 0.2 |
| | initiator | | valeronitrile) | | | | | |
| | | | (Azo type polymerization initiator) | | | | | |
| | | V601 | Dimethyl 2,2′-azobis(2-methyl | | | | | |
| | | | propionate) | | | | | |
| | | | (Azo type polymerization initiator) | | | | | |
| | Polymerization | HQME | Hydroquinone monomethylether | 0.002 | | 0.002 | 0.002 | 0.002 |
| | inhibitor | | | | | | | |

| | | | | | | | |
|---|---|---|---|---|---|---|---|
| Pigment | MA11 | Carbon black (*6) | 6.0 | 6.0 | 6.0 | 6.0 | 6.0 |
| Pigment dispersing agent | S28000 | Solsperse 28000 (*7) | | 0.6 | 0.6 | 0.6 | 0.6 |
| Diluent for dispersing | AF7 | Naphthene type solvent (*3) | 18.0 | 35.0 | 18.0 | 18.0 | 18.0 |
| Solvent for viscosity | AF7 | Naphthene type solvent (*3) | 23.1 | 5.0 | 22.0 | 23.9 | 28.0 |
| adjustment | IOP | Isooctyl palmitate (*4) | 20.5 | 50.4 | 20.9 | 15.4 | 10.9 |
| Post-added resin | Tamanol | Rosin-modified phenol resin (*8) | | 3.0 | | 3.0 | |
| | 420 | | | | | | |

| Number of parts of pigment | | 6.1 | 6.0 | 6.0 | 6.0 | 6.0 |
|---|---|---|---|---|---|---|
| Number of parts of polymer | | 4.0 | 3.6 | 4.5 | 7.6 | 8.6 |
| Polymer/pigment | | 0.65 | 0.60 | 0.77 | 1.27 | 1.43 |
| Physical | Viscosity (initial) | — | 9.8 | 10.7 | 11.9 | 9.8 |
| characteristics | Particle size (initial) | — | 90.3 | 94.6 | 95.1 | 94.7 |
| Evaluation | Storage stability | — | ∘ | Δ | ∘ | Δ |
| | Jetting-out stability | — | Δ | ∘ | x | x |
| | Image density of prints | — | x | Δ | ∘ | ∘ |
| | Ink offset to the back of printed paper | — | x | Δ | ∘ | ∘ |
| | Abrasion resistance | — | Δ | x | Δ | ∘ |

(*1): NOF Co., Ltd.
(*2): Toagosei Co., Ltd.
(*3): Nippon Oil Corporation
(*4): Nikko Chemicals Co., Ltd.
(*5): Nissan Chemical Industries, Ltd.
(*6): Mitsubishi Chemical Corporation
(*7): Noveon, Inc.
(*8): Arakawa Chemical Industries, Ltd.

With each of the non-aqueous pigment ink compositions in accordance with the present invention, which had been obtained in Examples 1 to 5, good storage stability under high-temperature environment conditions was capable of being obtained, and good jetting-out stability was capable of being obtained, while prints having a high image density were being formed. With the non-aqueous pigment ink composition obtained in Example 3, in which the proportion of the quantity of the pigment dispersive NAD particles with respect to the total quantity of the resin, including the pigment dispersive NAD particles, was less than 95% by mass, the jetting-out stability became slightly bad. Also, with the non-aqueous pigment ink composition obtained in Example 4, in which the proportion of the total quantity of the resin, including the pigment dispersive NAD particles, with respect to the quantity of the pigment contained in the ink composition was less than 50% by mass, the storage stability under high-temperature environment conditions became slightly bad. Further, with the non-aqueous pigment ink composition obtained in Example 5, in which the proportion of the total quantity of the resin, including the pigment dispersive NAD particles, with respect to the quantity of the pigment contained in the ink composition was higher than 100% by mass, the jetting-out stability became bad.

With the ink sample obtained in Comparative Example 1, in which the conventional NAD particles having no pigment dispersing ability were added, since the ink sample was not added with a particular pigment dispersing agent, the formation of the ink composition was not capable of being achieved. With the conventional non-aqueous pigment ink composition obtained in Comparative Example 2, in which the NAD particles having no pigment dispersing ability were not added, good storage stability was capable of being obtained. However, with the non-aqueous pigment ink composition obtained in Comparative Example 2, in which the quantity of the resin added was suppressed for obtaining the storage stability, prints having a high image density were not capable of being obtained, and the ink fixing characteristics (the abrasion resistance) were bad.

With the non-aqueous pigment ink composition obtained in Comparative Example 3, in which the NAD particles having no pigment dispersing ability and the particular pigment dispersing agent were added, good jetting-out stability was capable of being obtained. However, with the non-aqueous pigment ink composition obtained in Comparative Example 3, prints having a high image density were not capable of being obtained, and the ink fixing characteristics were not sufficiently good. In Comparative Example 4, the resin content was set to be higher than in Comparative Example 3, such that the image density of prints might be enhanced, and such that good ink fixing characteristics might be obtained. Also, in Comparative Example 5, the NAD particles content was set to be higher than in Comparative Example 4, such that the image density of prints might be enhanced, and such that good ink fixing characteristics might be obtained. With each of the non-aqueous pigment ink compositions obtained in Comparative Examples 4 and 5, the image density of prints was capable of being enhanced, and good ink fixing characteristics were capable of being obtained. However, with the non-aqueous pigment ink composition obtained in Comparative Example 4, the jetting-out stability and the abrasion resistance were not sufficiently good. Also, with the non-aqueous pigment ink composition obtained in Comparative Example 5, the storage stability and the jetting-out stability were not sufficiently good. From the results obtained in Comparative Examples 3, 4, and 5, it was found that, in cases where the conventional NAD particles having no pigment dispersing ability are utilized, both the requirements for the high image density of the prints and for the good ink fixing characteristics and the requirement for the high jetting-out stability were not always capable of being satisfied at the same time.

As described above, with the non-aqueous pigment ink composition in accordance with the present invention, which contains the non-aqueous resin dispersion fine particles having the pigment dispersing ability, the interaction between the pigment and the non-aqueous resin dispersion fine particles having the pigment dispersing ability is strong. Therefore, with the non-aqueous pigment ink composition in accordance with the present invention, in the region of a lower content than the NAD particles which do not have the pigment dispersing ability, prints having a high image density on plain paper are capable of being obtained. Therefore, with the non-aqueous pigment ink composition in accordance with the present invention, the jetting-out stability is capable of being enhanced. Further, with the non-aqueous pigment ink composition in accordance with the present invention, both the storage stability under the ordinary use environment conditions and the storage stability under high-temperature environment conditions are capable of being kept good. Furthermore, with the non-aqueous pigment ink composition in accordance with the present invention, both the requirements for the high image density of the prints and for the good ink fixing characteristics and the requirement for the high jetting-out stability are capable of being satisfied at the same time.

What is claimed is:

1. A non-aqueous pigment ink composition, containing at least a pigment, a solvent, and non-aqueous resin dispersion fine particles having pigment dispersing ability.

2. A non-aqueous pigment ink composition as defined in claim 1 wherein the non-aqueous resin dispersion fine particles are obtained from copolymerization of a polymerizable monomer mixture containing, as principal constituents, (meth) acrylic acid alkyl ester monomers, which are soluble in a solvent and which are capable of being insolubilized by undergoing polymerization, and the (meth)acrylic acid alkyl ester monomers contain:
i) at least one kind of monomer having a long chain alkyl group having 12 to 25 carbon atoms, and
ii) at least one kind of monomer having at least one kind of functional group selected from the group consisting of a tertiary amino group, a glycidyl group, a carboxyl group, and a macromonomer having a styrene-derived functional group.

3. A non-aqueous pigment ink composition as defined in claim 1 wherein a proportion of a total quantity of a resin, including the non-aqueous resin dispersion fine particles, with respect to the quantity of the pigment contained in the ink composition falls within the range of 50% by mass to 100% by mass, and the proportion of the quantity of the non-aqueous resin dispersion fine particles with respect to the total quantity of the resin, including the non-aqueous resin dispersion fine particles, is equal to at least 95% by mass.

4. A non-aqueous pigment ink composition as defined in claim 2 wherein a proportion of a total quantity of a resin, including the non-aqueous resin dispersion fine particles, with respect to the quantity of the pigment contained in the ink composition falls within the range of 50% by mass to 100% by mass, and the proportion of the quantity of the non-aqueous resin dispersion fine particles with respect to the total quantity of the resin, including the non-aqueous resin dispersion fine particles, is equal to at least 95% by mass.
